(19) United States
(12) Patent Application Publication
(10) Pub. No.: US 2024/0406111 A1
(43) Pub. Date: Dec. 5, 2024

(54) INFORMATION PROCESSING METHOD, INFORMATION PROCESSING DEVICE, AND STORAGE MEDIUM

(71) Applicant: TOYOTA JIDOSHA KABUSHIKI KAISHA, Toyota-shi (JP)

(72) Inventors: Toru FURUSAWA, Yokohama-shi (JP); Xiao SHAO, Kawasaki-shi (JP)

(73) Assignee: TOYOTA JIDOSHA KABUSHIKI KAISHA, Toyota-shi (JP)

(21) Appl. No.: 18/638,930

(22) Filed: Apr. 18, 2024

(30) Foreign Application Priority Data
Jun. 1, 2023 (JP) 2023-090775

(51) Int. Cl. H04L 47/125

(52) U.S. Cl. CPC H04L 47/125

(57) ABSTRACT

An information processing method that is performed by a computer includes acquiring first communication quality of a path on a user plane connecting to an external network within a core network. The method further includes, when determination is made based on the first communication quality to switch an offloading destination of traffic from a terminal between a first server on the external network and a second server in a local network, sending to the core network a first request instructing to change steering of the traffic from the terminal.

### CROSS-REFERENCE TO RELATED APPLICATION

This application claims priority to Japanese Patent Application No. 2023-090775 filed on Jun. 1, 2023, incorporated herein by reference in its entirety.

### BACKGROUND

### 1. Technical Field

The present disclosure relates to information processing methods, information processing devices, and storage media for switching the offloading destination of traffic from a terminal.

### 2. Description of Related Art

An information processing system is disclosed that determines which of an in-vehicle device, a cloud server, and an edge server is to run a container application, based on the processing time of the container application and the round-trip time (RTT) required for round-trip communication between the in-vehicle device and the cloud server or edge server (e.g., Japanese Unexamined Patent Application Publication No. 2022-080171 (JP 2022-080171 A)). There is disclosed a technology of switching an edge server by switching a Protocol Data Unit (PDU) Session Anchor-User Plane Function (PSA-UPF) based on the latency between a terminal and a PSA-UPF within a fifth generation (5G) core network connected to edge servers (e.g. 3GPP TS 23.548 V18.1.1 “5G System Enhancements for Edge Computing; Stage 2 (Release 18),” 3GPP TSG SA WG2, April 2023, “6.3.6 Edge Relocation Considering User Plane Latency Requirement”).

### SUMMARY

The present disclosure provides a method, device, and storage medium that allow switching of an offloading destination of part of processing of a terminal between a cloud and an edge server to be performed on the core network side.

According to an aspect of the present disclosure, an information processing method that is performed by a computer includes:
acquiring first communication quality of a path on a user plane connecting to an external network within a core network; and
when, based on the first communication quality, determination is made to switch an offloading destination of traffic from a terminal between a first server on the external network and a second server in a local network, sending to the core network a first request instructing to change steering of the traffic from the terminal.

According to another aspect of the present disclosure, an information processing device includes a processor configured to
acquire first communication quality of a path on a user plane connecting to an external network within a core network, and
when, based on the first communication quality, determination is made to switch an offloading destination of traffic from a terminal between a first server on the external network and a second server in a local network, send to the core network a first request instructing to change steering of the traffic from the terminal.

According to still another aspect of the present disclosure, a non-transitory storage medium stores instructions. The instructions are executable by one or more processors and cause the one or more processors to perform functions.

### The Functions Include:

acquiring first communication quality of a path on a user plane connecting to an external network within a core network; and
when, based on the first communication quality, determination is made to switch an offloading destination of traffic from a terminal between a first server on the external network and a second server in a local network, sending to the core network a first request instructing to change steering of the traffic from the terminal.

According to the present disclosure, switching of an offloading destination of part of processing of a terminal between a cloud and an edge server can be performed on the core network side.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 shows an example of the architecture of a fifth generation mobile communication system;

FIG. 2 illustrates an offloading destination switching process in a communication system;

FIG. 3 shows an example of the hardware configuration of an information processing device that can operate as each of Network Functions (NFs) including an Edge Cloud Switching Function (ECSF) and an external server;

FIG. 4 shows an example of the functional configuration of the ECSF;

FIG. 5 is an example of a flowchart of an offloading destination switching determination process of the ECSF;

FIG. 6 is an example of a process sequence from the offloading destination switching determination process of the ECSF until traffic steering settings for steering traffic to a new offloading destination are reflected in an UPF that serves as a switching point;

FIG. 7 shows an example of the system configuration of a communication system in Specific Example 1 of the configuration for accessing an edge server;

FIG. 8 shows an example of the sequence of an offloading destination switching process in the communication system of Specific Example 1;

FIG. 9 shows an example of the system configuration of a communication system in Specific Example 2 of the configuration for accessing an edge server;

FIG. 10 shows an example of the sequence of an offloading destination switching process in the communication system of Specific Example 2;

FIG. 11 shows an example of the system configuration of a communication system in Specific Example 3 of the configuration for accessing an edge server; and

FIG. 12 shows an example of the sequence of an offloading destination switching process in the communication system of Specific Example 3.

### DETAILED DESCRIPTION OF EMBODIMENTS

Executing part of calculation processing of a terminal on the server side via a network is called offload or offloading. Offloading allows even terminals with relatively few resources to perform more advanced processing. However, it may be difficult to implement such offloading when offloading processing that requires low latency responses and occurs continuously, such as real-time object detection processing based on video analysis of an in-vehicle camera, to a public cloud. This is because of the following reason. The communication quality is not guaranteed on the Internet for connecting to a public cloud. Therefore, if the communication latency in an Internet section increases, low latency communication may not be able to continue.

Low latency communication can be stably implemented by offloading processing to an edge server that can be directly connected from a mobile network without via the Internet. However, individual edge servers have limited resources compared to clouds. Therefore, if more terminals are offloaded to an edge server, the edge server may run out of its resources. In other words, there is an upper limit to the amount of traffic that can be offloaded to an edge server. Therefore, in order to stably continue processing that requires low latency responses and occurs continuously, the offloading destination of traffic from a terminal needs to be adjusted between a cloud and an edge server.

In one aspect of the present disclosure, in view of the above need, the offloading destination is switched between a cloud and an edge server according to the state of communication for the cloud. More specifically, one aspect of the present disclosure is a method that is performed by a computer. The method includes: acquiring at least communication quality of a path on a user plane connecting to an external network within a core network; and when, based on the communication quality, determination is made to switch an offloading destination of traffic from a terminal between a first server on the external network and a second server in a local network, sending to the core network a first request instructing to change steering of the traffic from the terminal.

The computer may be a computer within the core network or a computer outside the core network. The core network may be, for example, any one of fifth generation (5G), fourth generation (4G), sixth generation (6G), and subsequent generation mobile core networks. The core network may be a core network of a wired network. Examples of the path on the user plane connecting to the external network within the core network include a path between a User Plane Function (UPF) and an external network in 5G and a path between a Serving Gate Way (SGW) and a Packet Data Network Gate Way (PGW) in 4G. The second server is, for example, a server that operates as an edge server.

The communication quality is indicated by, for example, one or more of the following: latency, throughput, and jitter. The communication quality may be acquired from, for example, a device within or outside the core network that analyzes the network state, or may be acquired by the computer itself analyzing the network state.

According to the one aspect of the present disclosure, switching of the offloading destination of the traffic from the terminal can be controlled on the core network side without involvement of any of the terminal, the second server (edge server), and the first server on the cloud. Switching of the offloading destination of the traffic from the terminal can thus be dynamically performed without changing the configurations of the terminal, second server (edge server), and first server on the cloud. Since no resources for switching the offloading destination of the traffic from the terminal need be prepared on the terminal, the second server (edge server), and the first server on the cloud, the resources of these devices can be reduced.

In the one aspect of the present disclosure, when the communication quality of the path on the user plane connecting to the external network within the core network satisfies a first condition indicating that communication for the external network is stable, the computer may determine the first server on the external network to be the offloading destination of the traffic from the terminal. In this case, the first request that is sent by the computer may instruct to change a steering destination of the traffic from the terminal from the local network to the external network.

When the communication quality of the path on the user plane connecting to the external network within the core network does not satisfy the first condition, the computer may determine the second server in the local network to be the offloading destination. In this case, the first request that is sent by the computer may instruct to change the steering destination of the traffic from the terminal from the external network to the local network. The first condition is defined by, for example, one or more of the following: response latency, throughput, and jitter.

According to the one aspect of the present disclosure, offloading of the traffic from the terminal to the second server (edge server) in the local network can be limited to cases where communication for the external network is unstable. For example, communication of processing that requires low latency responses and occurs continuously can thus be stably provided to the terminal.

In the one aspect of the present disclosure, the computer may further acquire communication quality between the terminal and the core network for each of a plurality of the terminals. In this case, when communication quality between a first terminal and the first server on the external network satisfies a second condition, the computer may determine the first server on the external network to be an offloading destination of traffic from the first terminal. In this case, the first request that is sent by the computer may instruct to change a steering destination of the traffic from the first terminal from the local network to the external network.

When the communication quality between the first terminal and the first server on the external network does not satisfy the second condition, the computer may determine the second server in the local network to be the offloading destination of the traffic from the first terminal. In this case, the first request that is sent by the computer may instruct to change the steering destination of the traffic from the first terminal from the external network to the local network. The second condition is the same as the first condition.

According to the one aspect of the present disclosure, switching of the traffic offloading destination can be controlled on a terminal-by-terminal basis. The computer may determine to switch an offloading destination of traffic of a first application out of the traffic from the first terminal. Switching of the traffic offloading destination can thus be controlled on an application-by-application basis or on a flow-by-flow basis.

In the one aspect of the present disclosure, the core network may be a 5G core network. The computer may acquire, from a Network Data Analytics Function (NWDAF), communication quality between an UPF and the external network as the communication quality of the path on the user plane connecting to the external network within the core network. The computer may send the first request to a Policy Control Function (PCF) within the core network. Change of the steering of the traffic from the terminal based on the first request may be notified to a Session Management Function (SMF) by the PCF, and may be performed by the SMF controlling a predetermined UPF. Alternatively, the computer may send the first request to a Network Exposure Function (NEF). The NEF may notify the PCF of the first request. According to the one aspect of the present disclosure, the offloading destination of the traffic from the terminal can be switched on the 5G core network side by using functions of the 5G core network.

When the communication quality between the UPF and the external network satisfies a first condition indicating that communication for the external network is stable, the computer may determine the first server on the external network to be the offloading destination of the traffic from the terminal. When the communication quality between the UPF and the external network does not satisfy the first condition, the computer may determine the second server in the local network to be the offloading destination. Offloading of the traffic from the terminal to the second server (edge server) in the local network can thus be limited to cases where communication for the external network is unstable.

The computer may acquire, from the NWDAF, communication quality between the terminal and a first UPF and communication quality between the first UPF and the first server on the external network for each of a plurality of the terminals. When communication quality between a first terminal and the first server on the external network satisfies a second condition, the computer may determine the first server on the external network to be an offloading destination of traffic from the first terminal. When the communication quality between the first terminal and the first server on the external network does not satisfy the second condition, the computer may determine the second server in the local network to be the offloading destination of the traffic from the first terminal. Switching of the traffic offloading destination can thus be controlled on a terminal-by-terminal basis based on the communication qualities of the individual terminals. The first UPF is an edge UPF located at the boundary on the terminal side of the 5G network between the terminal and the cloud.

The predetermined UPF that changes steering of traffic from a first terminal may be an UPF located between the first terminal and the external network and acting as an Uplink Classifier (ULCL). By changing the steering of the traffic from the first terminal based on the first request, the ULCL may forward the traffic from the first terminal to either the external network or the local network where a server that is a new offloading destination indicated by a result of the determination to switch the offloading destination is present.

The predetermined UPF that changes steering of traffic from a first terminal may be an UPF that is a Branching Point located between the first terminal and a first PSA-UPF connected to the external network and located between the first terminal and a second PSA-UPF connected to the local network. By changing the steering of the traffic from the first terminal based on the first request, the UPF that is the Branching Point forwards, based on an IPV6 prefix, the traffic from the first terminal to either the first PSA-UPF or the second PSA-UPF that is a PSA-UPF connected to a network where a server that is a new offloading destination indicated by a result of the determination to switch the offloading destination is present.

The predetermined UPF that changes steering of traffic from a first terminal may be a first PSA-UPF connected to the external network and a second PSA-UPF connected to the local network. In this case, when changing steering of traffic from a first terminal based on the first request, the SMF may establish a new PDU session between the first terminal and either the first PSA-UPF or the second PSA-UPF that is a PSA-UPF connected to a network where a server that is a new offloading destination indicated by a result of the determination to switch the offloading destination is present, and release an exiting session between the first terminal and the other PSA-UPF to steer the traffic from the first terminal to either the first PSA-UPF or the second PSA-UPF that is the PSA-UPF connected to the network where the server that is the new offloading destination indicated by the result of the determination to switch the offloading destination is present.

Another aspect of the present disclosure can be specified as an information processing device that performs the above method. The information processing device includes a processor. The processor is configured to: acquire at least communication quality of a path on a user plane connecting to an external network within a core network; and when, based on the communication quality, determination is made to switch an offloading destination of traffic from a terminal between a first server on the external network and a second server in a local network, send to the core network a first request instructing to change steering of the traffic from the terminal. Other aspects of the present disclosure can be specified as a program for causing a computer to perform the above method, and a non-transitory computer-readable recording medium recording the program.

Hereinafter, embodiments of the present disclosure will be described with reference to the drawings. The configurations of the following embodiments are illustrative, and the present disclosure is not limited to the configurations of the embodiments.

### First Embodiment

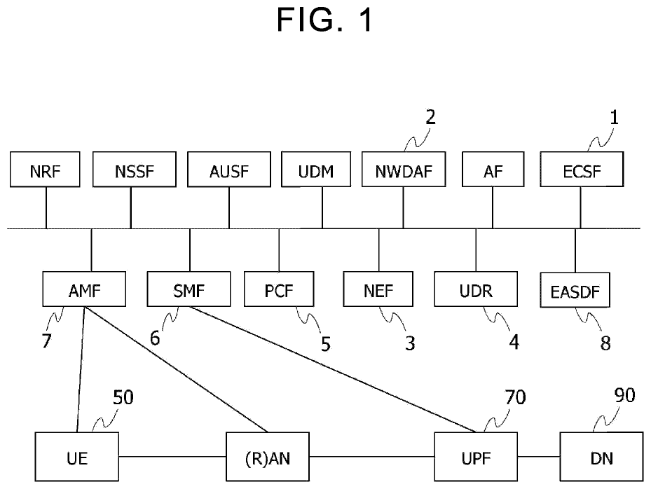

FIG. 1 shows an example of the architecture of a fifth generation (5G) mobile communication system. A fifth generation mobile communication network will be hereinafter referred to as “5G network.” The 5G network includes a 5G core network (5GC) and an access network ((R) AN). A user equipment (UE) 50, a data network (DN) 90, and an Application Function (AF) are connected to the 5G network. The UE 50 is a user's (subscriber's) terminal. A radio access network (RAN) is an access network to the 5GC. The RAN includes base stations (gNodeBs (gNBs)).

FIG. 1 shows part of components included in the 5GC. In FIG. 1, the components according to the first embodiment are denoted by signs. In the 5G, software that implements network functions and hardware on which the software is executed are separated using hardware abstraction technology. This allows software for various network functions to run on common hardware resources without depending on the configuration of each hardware product. FIG. 1 shows a plurality of network functions (NFs) included in the 5GC. Each of the NFs included in the 5GC is implemented by one or more computers (information processing devices) executing a program. A single computer may implement two or more of the NFs.

A User Plane Function (UPF) 70 is responsible for user packet routing and forwarding, packet inspection, and quality of service (QOS) handling. A user packet is a user plane packet that is sent and received by the UE 50.

An Access and Mobility Management Function (AMF) 7 accommodates the RAN and is responsible for registration management, connection management, and mobility management of the UE in the 5GC. The AMF 7 also relays messages between a Session Management Function (SMF) 6 and the UE 50.

The SMF 6 is responsible for management of Protocol Data Unit (PDU) sessions, allocation and management of IP addresses to UEs, and selection and control of the UPF 70. Management of PDU sessions includes establishment, modification, and release of PDU sessions. For example, when a policy is changed, a PDU session is changed, and a change in QoS or policy is applied to the UPF 70 through the SMF 6. A PDU session is a virtual communication channel for data transfer between the UE 50 and the DN 90. The DN 90 is a data network outside the 5GC (such as a cloud or the Internet).

A Policy Control Function (PCF) 5 is provided for each NF in order to enforce policy rules. The policy rules include, for example, rules regarding QoS, filtering, routing, and charging. When a policy rule is registered, changed, or deleted, this is first notified to the PCF 5, and the PCF 5 controls the corresponding UPF 70 to set, change, or delete the policy through the SMF 6.

A Unified Data Repository (UDR) 4 stores data to be used by a Unified Data Management (UDM), the PCF 5, and a Network Exposure Function (NEF) 3, and provides access to the data.

The NEF 3 provides a function to safely expose capabilities and event information exposed by network functions within a 5G system to external applications such as Application Function (AF). The NEF 3 also provides a function to receive information from authorized external applications into the network. The AF is an application server (external server) that provides auxiliary services other than the 5GC specifications.

A Network Data Analytics Function (NWDAF) 2 provides network analysis information. The network analysis information provided by the NWDAF 2 includes, for example, communication latency, throughput, jitter, and traffic load level in each section.

An Edge Application Server Discovery Function (EASDF) 8 mediates communication between the UE 50 and a Domain Name System (DNS) server.

A Network Repository Function (NRF) stores and manages information on the NFs (e.g., AMF, SMF, and UPF) within the 5GC. The NRF can reply to an inquiry source with a plurality of candidate NFs in response to an inquiry regarding the NF desired to be used. A Network Slice Selection Function (NSSF) has a function to select a network slice to be used by a subscriber from network slices created by network slicing. A network slice is a virtual network having specifications according to the intended use. An Authentication Server Function (AUSF) provides an UE authentication function. The UDM holds subscriber contract information and authentication information for Authentication and Key Agreement (AKA) authentication.

In the first embodiment, an Edge Cloud Switching Function (ECSF) 1 is newly added to the 5GC. The ECSF 1 controls switching of an offloading destination of traffic from the UE 50 between the DN 90 and an edge server in a local network. The ECSF 1 may be added as an NF within the 5GC, or may be added as one of AFs outside the 5GC. In the following description, it is assumed that the ECSF 1 is added as an NF within the 5GC.

A plurality of NFs of the same type may be prepared in the 5GC. For example, one NF may be prepared for each data center (exchange). Alternatively, one NF may be shared between or among the data centers. Alternatively, a plurality of NFs of the same type may be configured in one data center. The correspondence between the NFs and the data centers can be set as appropriate.

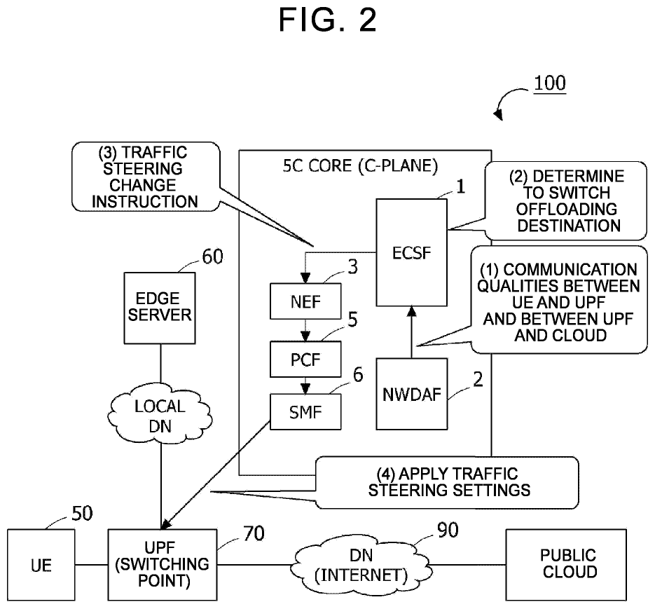

FIG. 2 illustrates an offloading destination switching process in a communication system 100. The offloading destination switching process is a process of dynamically switching the offloading destination of traffic from an UE between a server on a cloud and an edge server in a local network.

The communication system 100 includes the 5GC, the UE 50, the UPF 70, the DN 90, and an edge server 60. In FIG. 2, of the NFs included in the 5GC, the ECSF 1, NWDAF 2, NEF 3, PCF 5, and SMF 6 related to the offloading destination switching processing are extracted and shown in the communication system 100. However, the NFs involved in the offloading destination switching process are not limited to these. The edge server 60 is connected to a local DN within the same mobile network as the 5GC. A public cloud is connected to the DN 90. A server on the public cloud and the edge server 60 are running an application program for a service to be offloaded. It is assumed that the server on the public cloud and the edge server 60 are accessible from the UE 50 by using a common combination of service name, IP address, port number, protocol, etc.
(1) The ECSF 1 acquires information regarding the communication quality in a specified section at, for example, a predetermined cycle from the NWDAF 2. The specified section is, for example, a section between the UE 50 and a specified server on the cloud. The communication quality is indicated by, for example, communication latency, throughput, or jitter, or a combination of two or more of these. In this case, the information regarding the communication quality includes, for example, communication latency, throughput, and jitter.
(2) The ECSF 1 determines the offloading destination of traffic of the UE 50 to be either the server on the cloud or the edge server 60, based on the communication quality in the specified section. When communication for the cloud is stable, the server on the cloud is selected as the offloading destination of the UE 50. When communication for the cloud is not stable, the edge server 60 is selected as the offloading destination of the UE 50.
(3) The ECSF 1 outputs to the NEF 3 a traffic steering change instruction to switch steering of the traffic of the UE 50 to a new offloading destination. For example, information regarding the target UE 50 is also output together with the traffic steering change instruction. The traffic steering change instruction is an example of the “first request.”
(4) When the traffic steering change instruction is sent to the NEF 3, traffic steering settings for switching the traffic of the UE 50 to the new offloading destination are reflected in the UPF 70 that serves as a switching point to the traffic steering destination, through the NEF 3, the PCF 5, and the SMF 6. From then on, the traffic from the UE 50 is forwarded to the new offloading destination by the UPF 70.

This step (4) is performed according to the system configuration that is based on the method for accessing the edge server used in the 5G network. A specific example of the step (4) will be described later.

The UE 50, the edge server 60, and the server on the cloud are not involved in the above steps (1) to (4). In the above steps (1) to (4), the UE 50, the edge server 60, and the server on the cloud merely operate normally, and the offloading destination of the UE 50 is dynamically switched based on the communication quality between the UE 50 and the cloud. Therefore, dynamic switching of the offloading destination of the UE 50 can be controlled on the network side, and there is no need to change the configurations of the UE 50, edge server 60, and server on the cloud.

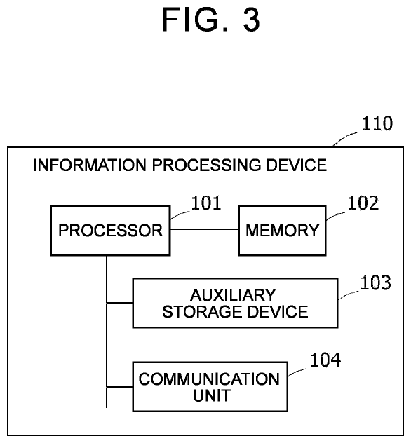

FIG. 3 shows an example of the hardware configuration of an information processing device 110 that can operate as each of NFs including the ECSF 1 and an external server. The information processing device 110 can be an information processing device (computer) such as a personal computer (PC), a workstation (WS), or a server machine. The information processing device 110 may be a collection of one or more computers (cloud). The NFs including the ECSF 1 may be devices including an electric circuit such as an field-programmable gate array (FPGA) or application specific integrated circuit (ASIC) dedicated to perform a corresponding process.

The information processing device 110 includes, as the hardware configuration, a processor 101, a memory 102, an auxiliary storage device 103, and a communication unit 104. The memory 102 and the auxiliary storage device 103 are computer-readable recording media. The processor 101, the auxiliary storage device 103, and the communication unit 104 are electrically connected to each other by a bus.

The auxiliary storage device 103 stores programs to be used for the information processing device 110 to operate as any one of the various NFs including the ECSF 1, and data to be used by the processor 101 when executing each program. The auxiliary storage device 103 is, for example, an erasable programmable read-only memory (EPROM), a hard disk drive (HDD), or a solid state drive (SSD). The programs held in the auxiliary storage device 103 include, for example, an operating system (OS), a control program for the ECSF 1, and a plurality of application programming interfaces (APIs) for the ECSF 1.

The memory 102 is a storage device that provides the processor 101 with a storage area and a working area for loading the programs stored in the auxiliary storage device 103 and that is used as a buffer. The memory 102 includes a semiconductor memory such as a read-only memory (ROM) and a random access memory (RAM).

The processor 101 performs processes corresponding to the various NFs by loading the OS and the programs related to the various NFs including the ECSF 1 held in the auxiliary storage device 103 into the memory 102 and executes them. The processor 101 is, for example, a central processing unit (CPU) or a digital signal processor (DSP). The number of processors 101 is not limited to one, and the information processing device 110 may include a plurality of processors. The processor 101 is an example of the “control unit.”

The communication unit 104 is, for example, a network interface card (NIC) or an optical line interface. The communication unit 104 may be, for example, a wireless communication circuit connected to a wireless network such as a wireless local area network (LAN). The hardware configuration of the information processing device 110 that implements the functions of various NFs including the ECSF 1 is not limited to the hardware configuration shown in FIG. 3.

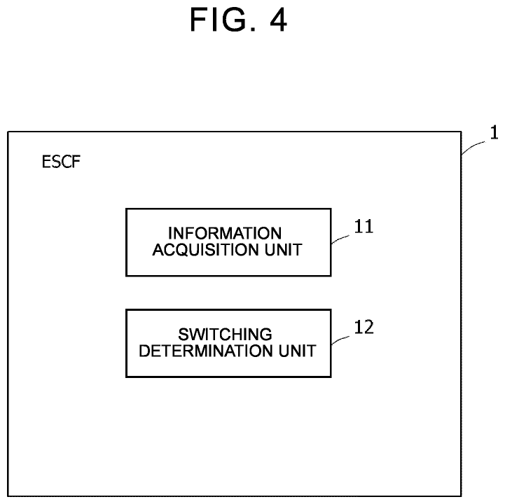

FIG. 4 shows an example of the functional configuration of the ECSF 1. The ECSF 1 includes, as the functional configuration, an information acquisition unit 11 and a switching determination unit 12. The information acquisition unit 11 acquires information regarding the communication quality in a specified section at a predetermined cycle from the NWDAF 2. The specified section is, for example, a section between a specified UE 50 and a specified server on the cloud. One UE 50 may be specified for the specified section, or a group of UEs may be specified for the specified section. In the NWDAF 2, information regarding the communication quality is acquired for each of the section between an UE and an UPF and the section between the UPF and a DN. Therefore, the information acquisition unit 11 acquires, from the NWDAF 2, information regarding the communication quality between a specified UE 50 and an edge UPF, and information regarding the communication quality between the edge UPF and a specified server on the cloud. The edge UPF is a UPF located at the boundary on the UE 50 side of the 5G network between the UE 50 and the cloud.

The specified section is set by, for example, an administrator of the ECSF 1. Either one UE 50 or a group of UEs 50 may be specified as the UE(s) 50 for which information regarding the communication quality is acquired. In this case, the information acquisition unit 11 may acquire, from the NWDAF 2, information regarding the communication quality in a plurality of specified sections. The information acquisition unit 11 may be, for example, an API for an Nnwdaf_AnalyticsSubscription_Subscribe service.

The switching determination unit 12 determines the offloading destination of the specified UE 50 based on the communication quality in the specified section. Information regarding the communication quality between the UE 50 and the edge UPF and information regarding the communication quality between the edge UPF and the specified server on the cloud are acquired from the NWDAF 2. Therefore, the switching determination unit 12 calculates the communication quality in the specified section based on the information regarding the communication quality between the UE 50 and the edge UPF and the information regarding the communication quality between the edge UPF and the specified server on the cloud. For example, in the case of communication latency, the sum of the communication latency between the UE 50 and the edge UPF and the communication latency between the edge UPF and the specified server on the cloud may be used as the communication quality in the specified section.

The switching determination unit 12 determines whether communication for the cloud is stable, based on whether communication quality conditions are satisfied. The communication quality conditions are conditions indicating that communication for the cloud is stable. The communication quality conditions are defined using, for example, a value required for stable communication (required value) for each type of information indicating the communication quality. For example, when the information indicating the communication quality is communication latency, the communication quality conditions include that the average round-trip latency in a predetermined time period is equal to or greater than the required value. The communication quality conditions are not limited to this, and may include conditions related to, for example, throughput and jitter. The communication quality conditions may include a condition for each type of information regarding the communication quality, or may include a plurality of conditions for one type of communication quality information.

The switching determination unit 12 determines to switch the offloading destination of the UE 50 when, for example, the determination result as to whether the communication quality conditions are satisfied has changed. When the communication quality conditions are satisfied, the switching determination unit 12 determines the offloading destination of the UE 50 to be the server on the cloud. When the communication quality conditions are not satisfied, the switching determination unit 12 determines the offloading destination of the UE 50 to be the edge server 60. When the switching determination unit 12 determines to switch the offloading destination of the UE 50, the switching determination unit 12 sends a traffic steering change instruction to the NEF 3. The traffic steering change instruction is an instruction to steer the traffic from the UE 50 to a network where the server that is a new offloading destination is present. Information on the target UE 50 and information on the network that is a steering destination are also sent to the NEF 3 together with the traffic steering change instruction. The information on the target UE 50 is, for example, identification information of the UE 50 such as an IP address. The information on the network that is a steering destination is, for example, identification information of a local DN or a cloud DN depending on the location of the UE 50.

The traffic steering change instruction may be sent to the NEF 3 through, for example, an API for an Nnef_TrafficInfluence service. When the ECSF 1 can access the PCF 5 without via the NEF 3, the traffic steering change instruction may be directly sent from the ECSF 1 to the PCF 5 through an API for an Npcf_PolicyAuthorization service.

When the NEF 3 receives the traffic steering change instruction, the process proceeds from the NEF 3 to the PCF 5 and then from the PCF 5 to the SMF 6, the SMF 6 reflects the traffic steering settings in the UPF 70 that serves as a switching point. This will be described in detail later. The functional configuration of the ECSF 1 is not limited to the configuration shown in FIG. 4, and may be modified as appropriate depending on the embodiment.

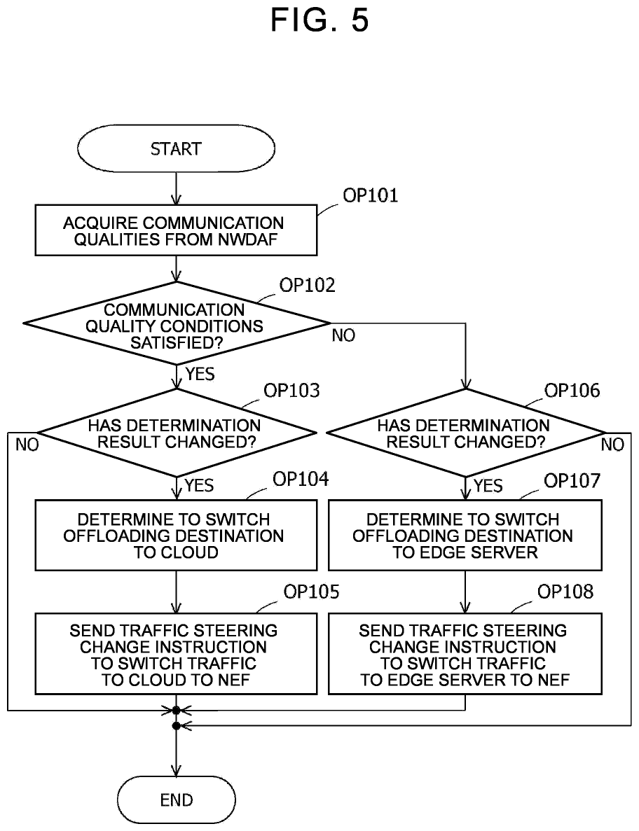

FIG. 5 is an example of a flowchart of an offloading destination switching determination process of the ECSF 1. The process shown in FIG. 5 is repeatedly performed at, for example, a predetermined cycle. The interval at which the process shown in FIG. 5 is performed is set as desired in the range of one second to 60 seconds by the administrator of the ECSF 1. The process shown in FIG. 5 is mainly performed by the processor 101 of the information processing device 110 that performs the process of the ECSF 1. However, in the following description, the process shown in FIG. 5 is described to be mainly performed by functional components for convenience.

In OP101, the information acquisition unit 11 acquires, from the NWDAF 2, information regarding the communication qualities in the section between a specified UE 50 and an edge UPF and the section between the edge UPF and a specified server on the cloud. The switching determination unit 12 acquires the communication quality in a specified section (between the specified UE 50 and the specified server on the cloud) based on the information regarding the communication quality in the two sections acquired from the NWDAF 2.

In OP102, the switching determination unit 12 determines whether the communication quality in the specified section satisfies the communication quality conditions. When the communication quality in the specified section satisfies the communication quality conditions (OP102: YES), the process proceeds to OP103. When the communication quality in the specified section does not satisfy the communication quality conditions (OP102: NO), the process proceeds to OP106.

OP103 to OP105 are the steps to be performed when the communication quality in the specified section satisfies the communication quality conditions. In OP103, the switching determination unit 12 determines whether the determination result in OP 102 as to whether the communication quality in the specified section satisfies the communication quality conditions has changed from the previous time. When the determination result in OP102 has not changed from the previous time (OP103: NO), it indicates that communication for the cloud has not changed from a stable state. In this case, the switching determination unit 12 determines not to switch the offloading destination of the specified UE 50, and the process shown in FIG. 5 ends.

When the determination result in OP102 has changed from the previous time (OP103: YES), it indicates that communication for the cloud has changed from an unstable state to a stable state, and the process proceeds to OP104. In OP104, the switching determination unit 12 determines to switch the offloading destination of the specified UE 50 to the specified server on the cloud.

In OP105, the switching determination unit 12 sends to the NEF 3 a traffic steering change instruction to switch the traffic of the specified UE 50 to the specified server on the cloud. Information on the specified UE 50 and information on the specified server on the cloud are also sent together with the traffic steering change instruction. After that, the process shown in FIG. 5 ends.

OP106 to OP108 are the steps to be performed when the communication quality in the specified section does not satisfy the communication quality conditions. In OP106, the switching determination unit 12 determines whether the determination result in OP 102 as to whether the communication quality in the specified section satisfies the communication quality conditions has changed from the previous time. When the determination result in OP102 has not changed from the previous time (OP106: NO), it indicates that communication for the cloud has not changed from an unstable state. In this case, the switching determination unit 12 determines not to switch the offloading destination of the specified UE 50, and the process shown in FIG. 5 ends.

When the determination result in OP102 has changed from the previous time (OP106: YES), it indicates that communication for the cloud has changed from a stable state to an unstable state, and the process proceeds to OP107. In OP107, the switching determination unit 12 determines to switch the offloading destination of the specified UE 50 to the edge server 60.

In OP108, the switching determination unit 12 sends to the NEF 3 a traffic steering change instruction to switch the traffic of the specified UE 50 to the edge server 60. Information on the specified UE 50 and information indicating that the new offloading destination is the edge server 60 are also sent together with the traffic steering change instruction. After that, the process shown in FIG. 5 ends. The offloading destination switching determination process of the ECSF 1 is not limited to the process shown in FIG. 5, and may be modified as appropriate depending on the embodiment.

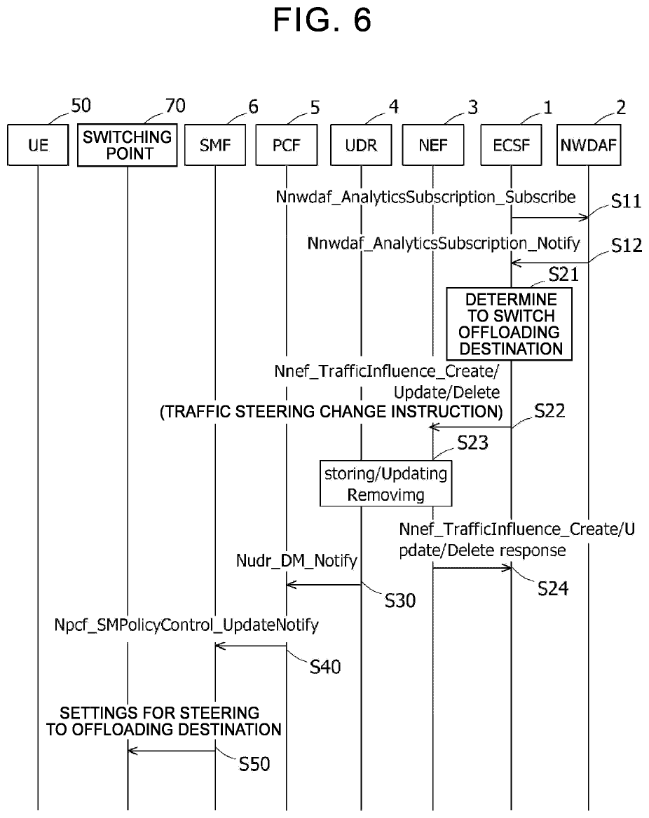

FIG. 6 is an example of a process sequence from the offloading destination switching determination process of the ECSF 1 until the traffic steering settings for switching the traffic of the UE to a new offloading destination are reflected in the UPF 70 that serves as a switching point.

In S11, the ECSF 1 sends an Nnwdaf_AnalyticsSubscription_Subscribe message to the NWDAF 2. The Nnwdaf_AnalyticsSubscription_Subscribe message is an information acquisition request to the NWDAF 2. Information on the section to be acquired (between the UE 50 and the edge UPF, and between the edge UPF and the cloud) and information regarding the acquired communication quality is also sent together with the Nnwdaf_AnalyticsSubscription_Subscribe message.

In S12, the NWDAF 2 sends an Nnwdaf_AnalyticsSubscription_Notify message to the ECSF 1. The Nnwdaf_AnalyticsSubscription_Notify message is a message notifying the information requested by the Nnwdaf_AnalyticsSubscription_Subscribe message. As a result, the ECSF 1 acquires information regarding the communication quality in the specified section (FIG. 5, OP101).

In S21, the ECSF 1 determines to switch the offloading destination of the UE 50, based on the information regarding the communication quality in the specified section (FIG. 5, OP104 or OP107). In S22, the ECSF 1 sends an Nnef_TrafficInfluence_Create (or Update or Delete) message to the NEF 3. The Nnef_TrafficInfluence_Create (or Update or Delete) message is a message that is used to request the 5GC to change traffic routing etc. In the first embodiment, the Nnef_TrafficInfluence_Create (or Update or Delete) message is a traffic steering change instruction to switch the traffic of the UE 50 to a new offloading destination. A parameter instructing to switch the offloading destination between the edge server and the server on the cloud, the IP address of the UE 50, information on the current offloading destination, information on the new offloading destination, and a Data Network Access Identifier (DNAI) are also sent together with the Nnef_TrafficInfluence_Create (or Update or Delete) message. Examples of the information on the offloading destination include the server's IP address, port number, and Uniform Resource Identifier (URI). A policy rule is thus shown that includes switching of the steering destination of the traffic of the target UE 50 to the new offloading destination.

In S23, the NEF 3 stores the policy rule received together with the Nnef_TrafficInfluence_Create (or Update or Delete) message in the UDR 4 (in the case of the Nnef_TrafficInfluence_Create message or the Nnef_TrafficInfluence_Update message). In S24, the NEF3 sends an Nnef_TrafficInfluence_Create (or Update, Delete) response message to the ECSF1.

In S30, the UDR 4 sends to the PCF 5 an Nudr_DM_Notify message notifying that the policy rule has been changed. The policy rule is also sent together with the Nudr_DM_Notify message.

In S40, the PCF 5 sends to the SMF 6 an Npcf_SMPolicyControl_UpdateNotify message providing an update on the policy rule applied to a PDU session. A policy and charging control (PCC) rule created by the PCF 5 based on the policy rule is also sent together with the Npcf_SMPolicyControl_UpdateNotify message. The created PCC rule includes information on AF influenced Traffic Steering Enforcement Control. The information on AF influenced Traffic Steering Enforcement Control in the PCC rule includes information on a parameter instructing to switch the offloading destination between the edge server and the server on the cloud, the IP address of the UE 50, information on the current offloading destination, information on the new offloading destination, and a Data Network Access Identifier (DNAI). Examples of the information on the offloading destination include the server's IP address, port number, and Uniform Resource Identifier (URI).

In S50, the SMF 6 reflects in the UPF 70 that serves as a switching point the settings for switching the steering destination of the traffic of the target UE 50 from the current offloading destination to the new offloading destination, according to the PCC rule provided by the PCF 5. S50 and the subsequent steps vary depending on the method for accessing an edge server used in the 5G network, and therefore will be described below using specific examples.

Specific Examples of Configuration for Accessing Edge Server The process of switching the offloading destination of the UE 50 is mainly performed by the SMF 8, the UPF, etc. In order to switch the offloading destination, access to an edge server needs to be established. There are the following three examples of the configuration for accessing an edge server.
(Specific Example 1) Configuration using an UpLink CLassifier (ULCL)
(Specific Example 2) Configuration using IPv6 multihoming
(Specific Example 3) Configuration that switches a PDU session
The configuration of the 5GC is the same in all the specific examples.

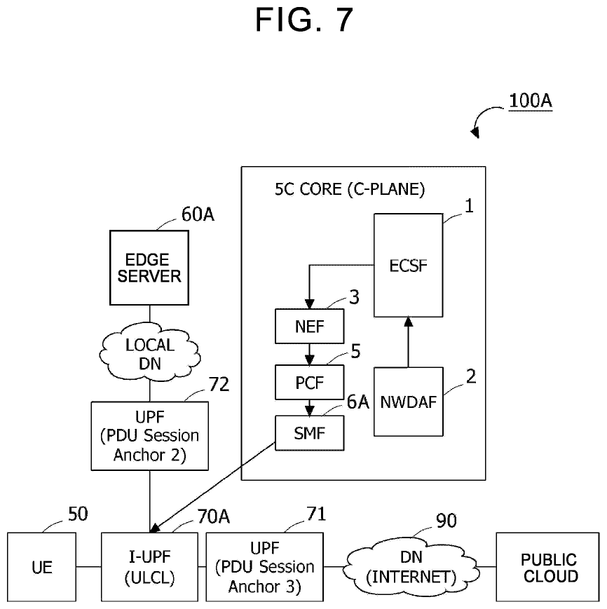

FIG. 7 shows an example of the system configuration of a communication system 100A in Specific Example 1 of the configuration for accessing an edge server. In the communication system 100A shown in FIG. 7, an ULCL is used as the configuration for switching the offloading destination. An ULCL is a function to separate specified uplink traffic of a PDU session and route it to a plurality of UPFs that serve as anchors of the PDU session. An UPF that serves as an anchor of the PDU session refers to the last UPF to relay the PDU session in the uplink direction from the UE 50. An UPF that serves as an anchor of the PDU session will be hereinafter referred to as “PDU Session Anchor-User Plane Function (PSA-UPF).

Traffic to be separated by the ULCL can be identified by an IP 5-tuple. An IP 5-tuple refers to a source IP address, a destination IP address, a protocol number, a source port number, and a destination port number. An ULCL is a function supported by a UPF. Since an UPF acting as an ULCL is located between the UE 50 and the PSA-UPF, it is also called an intermediate-UPF (I-UPF).

The communication system 100A includes an I-UPF 70A that is a ULCL, a PSA-UPF 71 that is connected to the DN 90 connected to the cloud, and a PSA-UPF 72 that is connected to a local DN to which an edge server 60A is connected. Hereinafter, the I-UPF 70A that is an ULCL will be simply referred to as “ULCL 70A.”

In the communication system 100A, the ULCL 70A serves as a switching point. The ECSF 1 acquires, from the NWDAF 2, information regarding the communication quality between the UE 50 and the PSA-UPF 71 and information regarding the communication quality between the PSA-UPF 71 and the server on the cloud. In the communication system 100A as well, the offloading destination switching process of the ECSF 1 (FIG. 5) and the sequence in the control plane when switching of the offloading destination occurs (FIG. 6) are as described above.

When using an ULCL, the traffic to be separated can be specified using an IP 5-tuple. Therefore, the granularity of the traffic whose offloading destination is to be switched can be set on a flow-by-flow basis that is finer than on a UE-by-UE basis. Accordingly, in the communication system 100A, when the ECSF 1 determines to switch the offloading destination, it may specify the traffic of the UE 50 whose offloading destination is to be switched by an IP 5-tuple, and cause the offloading destination of part of the traffic from the UE 50 to be switched. When communication for the cloud is not stable, the offloading destination of the traffic related to processing that requires low latency responses and occurs continuously may be preferentially switched from the cloud to the edge server 60. Examples of the processing that requires low latency responses and occurs continuously include real-time object detection processing for video analysis of an in-vehicle camera, autonomous driving, and metaverse applications. For example, specification of the traffic whose offloading destination is to be preferentially switched is set in advance in the ECSF 1 by the administrator of the ECSF 1, and is included in a policy rule and sent from the ECSF 1 to the ULCL 70A through the NEF 3, the UDR 4, the PCF 5, and an SMF 6A.

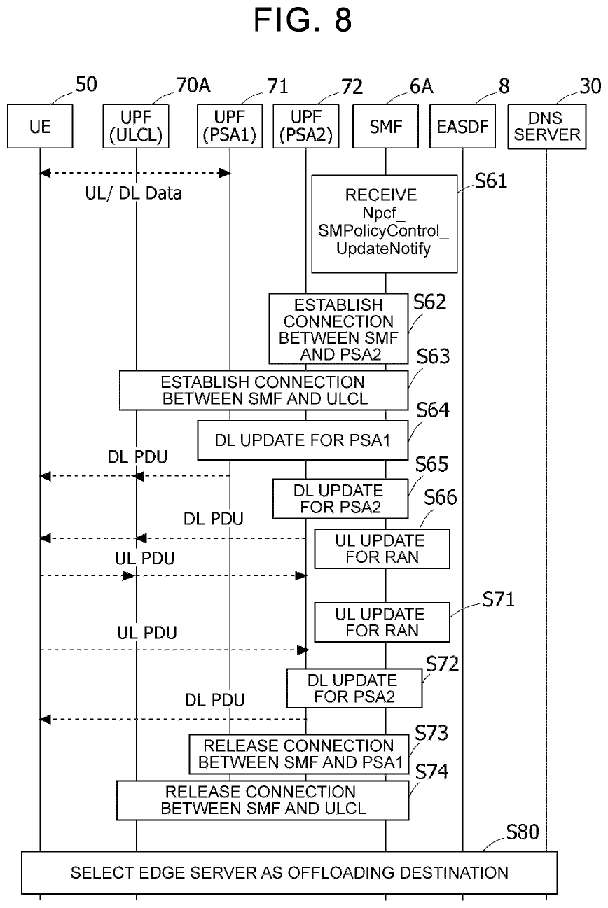

FIG. 8 shows an example of the sequence of an offloading destination switching process in the communication system 100A of Specific Example 1. The sequence of the process shown in FIG. 8 is, for example, the sequence of a process that is performed after the sequence of the process shown in FIG. 6 occurs in the communication system 100A. Namely, the process shown in FIG. 8 is performed after the ECSF 1 determines to switch the offloading destination of the UE 50 in S21 and steps S22 to S40 are performed. Description will be given with reference to FIG. 8 on the assumption that the offloading destination of the UE 50 is to be switched from the server on the cloud to the edge server 60A. Therefore, it is assumed that, in FIG. 8, the UE 50 has already established a PDU session with the PSA-UPF 71 that is connected to the DN 90 connected to the cloud. The PSA-UPF 71 is referred to as “UPF (PSA1)” in FIG. 8.

S61 corresponds to S40 in FIG. 6. In S61, the SMF 6A receives an Npcf_SMPolicyControl_UpdateNotify message from the PCF 5. A policy rule including switching of the offloading destination of the specified traffic from the UE 50 to the edge server 60A is also received from the PCF 5.

Steps S62 to S66 are the steps of newly adding a PSA-UPF and an ULCL (see 4.3.5.4 of TS 23.502). In S62, since the policy rule indicates an instruction to relocate the edge server, the SMF 6A selects the PSA-UPF 72 connected to the local DN that will be a new offloading destination of the specified traffic, and establishes connection with the PSA-UPF 72 (sends and receives an N4 session establishment request/response message). The PSA-UPF 72 is selected based on, for example, a Data Network Access Identifier (DNAI) of the local DN that will be a new offloading destination as indicated in the policy rule, and the location information of the UE 50 (see 6.3.3.3 of TS 23.502). The PSA-UPF 72 is referred to as “UPF (PSA2)” in FIG. 8.

In S63, the SMF 6A selects an UPF that acts as the ULCL 70A according to the policy rule, and establishes connection with the ULCL 70A (sends and receives an N4 session establishment request/response message). At this time, information on the traffic to be forwarded to each of the PSA-UPF 71 and PSA-UPF 72 is also applied to the ULCL 70A. Settings for switching the offloading destination are thus reflected in the ULCL 70A.

In S64, the SMF 6A updates settings of the PSA-UPF 71 so that the downlink traffic of the UE 50 is forwarded to the ULCL 70A. In S65, the SMF 6A updates settings of the PSA-UPF 72 so that the downlink traffic of the UE 50 is forwarded to the ULCL 70A. The downlink traffic for the uplink traffic of the UE 50 separated by the ULCL 70A is merged in the ULCL 70A by steps S64 and S65.

In S66, the SMF 6A updates RAN settings through the AMF 7 so that the UPF side of an N3 tunnel is terminated at the ULCL 70A (so that the next hop as seen from the UE 50 is the ULCL 70A). This allows the uplink traffic of the UE 50 to first reach the ULCL 70A.

From then on, the specified uplink traffic from the UE 50 is separated by the ULCL 70A and forwarded to the PSA-UPF 72. Traffic other than the specified uplink traffic from the UE 50A continues to be forwarded to the PSA-UPF 71 by the ULCL 70A.

On the other hand, for example, when switching the offloading destination of all traffic from the UE 50 to the edge server 60A, the uplink traffic from the UE 50 does not need to be separated by the ULCL 70, so that no traffic will be forwarded to the PSA-UPF 71. In this case, steps S71 to S74 are performed to release the PDU session between the UE 50 and the PSA-UPF 71 (see 4.3.5.5.1 of TS 23.502).

In S71, the SMF 6A updates the RAN settings through the AMF 7 so that the UPF side of the N3 tunnel is terminated at the PSA-UPF 72 (so that the next hop as seen from the UE 50 is the PSA-UPF 72). This allows the uplink traffic of the UE 50 to reach the PSA-UPF 72 without via the ULCL 70A.

In S72, the SMF 6A updates settings of the PSA-UPF 72 so that the downlink traffic of the UE 50 is forwarded to the UE 50 without via the ULCL 70A.

In S73, the SMF 6A releases the connection with the PSA-UPF 71 (sends and receives an N4 session release request/response message). In S74, the SMF 6A releases the connection with the ULCL 70A (sends and receives an N4 session release request/response message). From then on, the traffic of the UE 50 is offloaded to the PSA-UPF 72 (local breakout).

Even when a PDU session between the UE 50 and the PSA-UPF 72 is established, the UE 50 does not know the edge server 60A and therefore searches for the edge server 60A. S80 is the step of searching for the edge server 60A, and the edge server 60A is selected by the sequence of the process among the SMF 6A, the UE 50, the EASDF 8, and the DNS server 30 according to 6.2.3.2.2 of TS 23.548.

The sequence when switching the offloading destination of the traffic from the UE 50 from the server on the cloud to the edge server 60A is illustrated in FIG. 8. Switching of the offloading destination of the traffic from the UE 50 from the edge server 60A to the server on the cloud can also be implemented in a similar manner. The ULCL may be configured on the same UPF as the PSA-UPF 72.

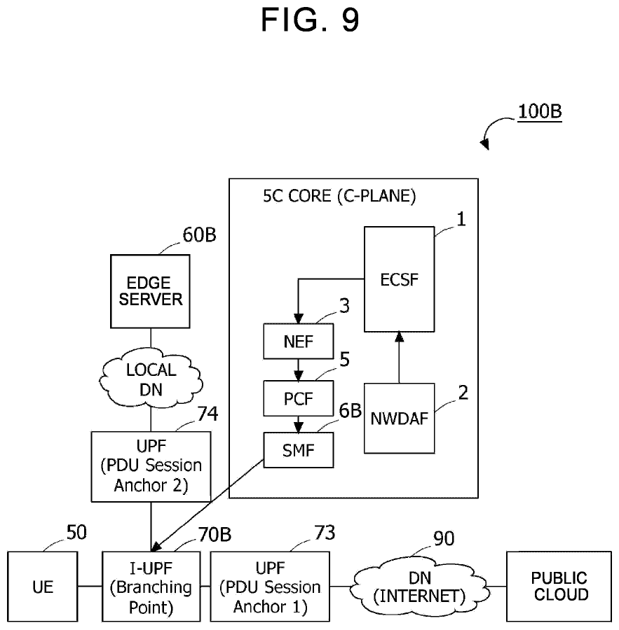

FIG. 9 shows an example of the system configuration of a communication system 100B in Specific Example 2 of the configuration for accessing an edge server. In the communication system 100B shown in FIG. 9, IPv6 multihoming is used as a configuration for switching the offloading destination. Multihoming refers to connecting to an external network through a plurality of paths.

The communication system 100B includes an I-UPF 70B that serves as a Branching Point, a PSA-UPF 73 that is connected the DN 90 connected to the cloud, and a PSA-UPF 74 that is connected to a local DN to which an edge server 60B connected. Hereinafter, the I-UPF 70B serving as a Branching Point will be simply referred to as “BP 70B.”

In the communication system 100B, the BP 70B serves as a switching point. The ECSF 1 acquires, from the NWDAF 2, information regarding the communication quality between the UE 50 and the PSA-UPF 73 and information regarding the communication quality between the PSA-UPF 73 and the server on the cloud. In the communication system 100B as well, the offloading destination switching process of the ECSF 1 (FIG. 5) and the sequence in the control plane when switching of the offloading destination occurs (FIG. 6) are as described above.

When using IPv6 multihoming, the BP 70B branches traffic based on the prefix of a source IPv6 address. Therefore, an IPV6 prefix to be forwarded to the PSA-UPF 74 connected to the edge server 60B is newly assigned to a PDU session. The ECSF 1 may specify the traffic to be forwarded to the PSA-UPF 74 by, for example, an IP 5-tuple. For example, information on the traffic to be forwarded to the edge server 60B is set in advance in the ECSF 1 by the administrator of the ECSF 1, and is included in a policy rule and sent from the ECSF 1 to the ULCL 70B through the NEF 3, the UDR 4, the PCF 5, and an SMF 6B.

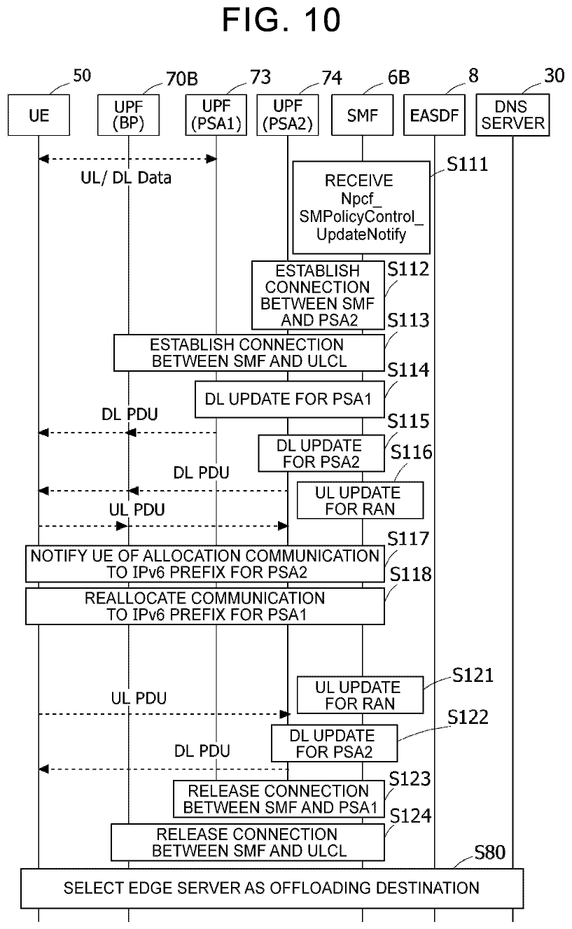

FIG. 10 shows an example of the sequence of an offloading destination switching process in the communication system 100B of Specific Example 2. For example, the process shown in FIG. 10 is performed following the sequence of the process shown in FIG. 6. Description will be given with reference to FIG. 10 on the assumption that the offloading destination of the UE 50 is to be switched from the server on the cloud to the edge server 60B. Therefore, it is assumed that, in FIG. 10, the UE 50 has already established an IPv6 multihoming PDU session with the PSA-UPF 73 that is connected to the DN 90 connected to the cloud.

Steps S111 to S116 are the same as steps S61 to S66 in the sequence of Specific Example 1 in FIG. 8, respectively. In S113, the SMF 6B notifies the BP 70B of the source IPv6 prefix of the PDU session that is to be forwarded to each of the PSA-UPF 73 and the PSA-UPF 74.

In S117, the SMF 6B notifies the UE 50 of a new IPv6 prefix allocated for forwarding to the PSA-UPF 74 (PSA-UPF 74 forwarding IPv6 prefix). The notification in S117 is performed by the SMF 6B through the PSA-UPF 74 using an IPV6 Router Advertisement message. In S117, the SMF 6B notifies the UE 50 of a policy rule indicating that the PSA-UPF74 forwarding IPv6 prefix is used in specified traffic (e.g., a real-time object detection processing for video analysis of an in-vehicle camera, autonomous driving, and metaverse). As a result, the UE 50 will use the PSA-UPF 74 forwarding IPv6 prefix as a source IPv6 prefix of the specified traffic, so that the BP 70B will forward the specified traffic to the PSA-UPF 74.

In S118, the SMF 6B reallocates an originally used IPv6 prefix for forwarding to the PSA-UPF 73 (PSA-UPF 73 forwarding IPv6 prefix) so that the UE 50 uses it for traffic other than the specified traffic. As a result, the UE 50 will use the PSA-UPF 73 forwarding IPv6 prefix as a source IPv6 prefix for traffic other than the specified traffic, so that the BP 70B will forward the traffic other than the specified traffic to the PSA-UPF 73.

For example, when switching the offloading destination of all traffic from the UE 50 to the edge server 60, there will be no traffic allocated to use the PSA-UPF 73 forwarding IPv6 prefix any more in S118. The BP 70B will not need to branch the traffic from the UE 50. In this case, steps S121 to S124 for releasing the PDU session between the UE 50 and the PSA-UPF 73 are performed. Steps S121 to S124 are the same as steps S71 to S74 in FIG. 8 of Specific Example 1. After that, in Specific Example 2 as well, a process for searching for the edge server 60B is performed by the SMF 6B, the UE 50, the EASDF 8, and the DNS server 30 as in Specific Example 1 (S80).

The sequence when switching the offloading destination of the traffic from the UE 50 from the server on the cloud to the edge server 60B is illustrated in FIG. 10. Switching of the offloading destination of the traffic from the UE 50 from the edge server 60B to the server on the cloud can also be implemented in a similar manner. The BP 70B may be configured on the same UPF as the PSA-UPF 74.

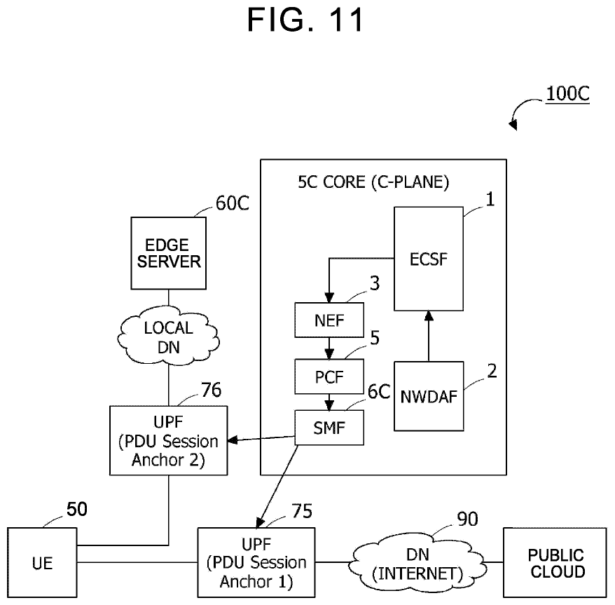

FIG. 11 shows an example of the system configuration of a communication system 100C in Specific Example 3 of the configuration for accessing an edge server. In the communication system 100C shown in FIG. 11, IPv6 multihoming is used as a configuration for switching the offloading destination in order to switch a PDU session.

The communication system 100C includes a PSA-UPF 75 that is connected to the DN 90 connected to the cloud, and a PSA-UPF 76 that is connected to a local DN to which an edge server 60C is connected. As shown in FIG. 11, when the PSA-UPF 75 connected to the cloud and the PSA-UPF 76 connected to the edge server 60 are different, there is no UPF 70 that clearly serves as a switching point in the communication system 100C.

The ECSF 1 acquires, from the NWDAF 2, information regarding the communication quality between the UE 50 and the PSA-UPF 75 and information regarding the communication quality between the PSA-UPF 75 and the server on the cloud. In the communication system 100C as well, the offloading destination switching process of the ECSF 1 (FIG. 5) and the sequence in the control plane when switching of the offloading destination occurs (FIG. 6) are as described above.

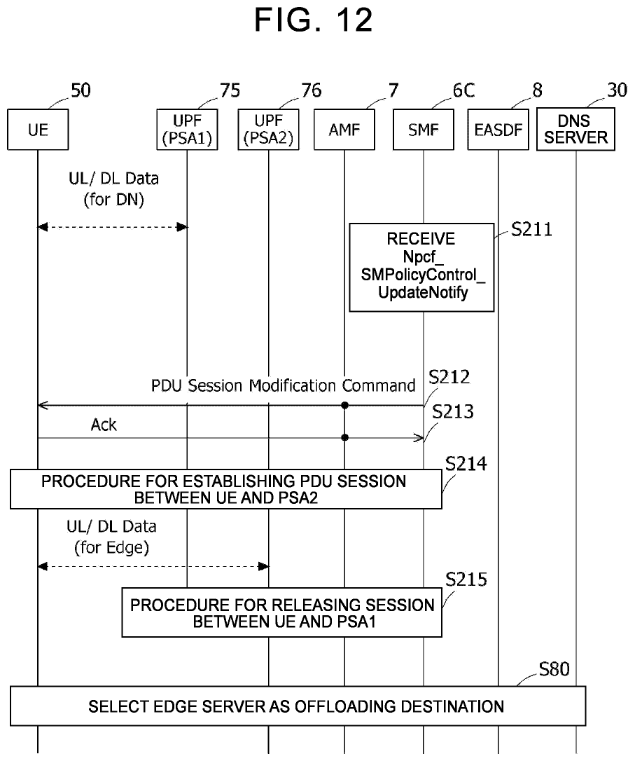

FIG. 12 shows an example of the sequence of an offloading destination switching process in the communication system 100C of Specific Example 3. For example, the process shown in FIG. 12 is performed following the sequence of the process shown in FIG. 6. Description will be given with reference to FIG. 12 on the assumption that the offloading destination of all traffic from the UE 50 is to be switched from the server on the cloud to the edge server 60C. Therefore, it is assumed that, in FIG. 12, the UE 50 has already established a PDU session with the PSA-UPF 75 that is connected to the DN 90 connected to the cloud.

S211 corresponds to S40 in FIG. 6. In S211, an SMF 6C receives an Npcf_SMPolicyControl_UpdateNotify message from the PCF 5. A policy rule including switching of the offloading destination of all traffic from the UE 50 to the edge server 60C is also received from the PCF 5.

In S212, the SMF 6C sends a PDU Session Modification Command to the UE 50 via the AMF 7. The PDU Session Modification Command sent in S212 instructs the UE 50 to release the PDU session with the PSA-UPF 75 connected to the server on the cloud and to establish a PDU session with the PSA-UPF 76 connected to the local DN. The PDU session with the PSA-UPF 75 connected to the server on the cloud may be released first, or the PDU session with the PSA-UPF 76 connected to the local DN may be established first. In S213, the UE 50 sends an acknowledgement to the PDU Session Modification Command to the SMF 6C via the AMF 7.

In S214, a procedure for establishing the PDU session between the UE 50 and the PSA-UPF 76 is performed (see 4.3.2.2.1 of TS 23.502). Once the PDU session between the UE 50 and the PSA-UPF 76 is established, the UE 50 can start communication using this new PDU session.

In S215, a procedure for releasing the PDU session between the UE 50 and the PSA-UPF 75 is performed (see 4.3.4.2 of TS 23.502). As a result, all traffic from the UE 50 will be offloaded to the edge server 60C. After that, in Specific Example 3 as well, a process for searching for the edge server 60C is performed by the SMF 6C, the UE 50, the EASDF 8, and the DNS server 30 as in Specific Examples 1 and 2 (S80).

The sequence when switching the offloading destination of the traffic from the UE 50 from the server on the cloud to the edge server 60C is illustrated in FIG. 12. Switching of the offloading destination of the traffic from the UE 50 from the edge server 60C to the server on the cloud can also be implemented in a similar manner.

In FIG. 12, the offloading destination of all traffic from the UE 50 is switched from the server on the cloud to the edge server 60C. However, the present disclosure is not limited to this. Of the traffic from the UE 50, the ECSF 1 can also specify the traffic whose offloading destination is to be switched by using, for example, an IP 5-tuple. When the traffic whose offloading destination is to be switched is specified, a PDU session between the UE 50 and the PSA-UPF 76 can be added for the specified traffic, and the existing PDU session between the UE 50 and the PSA-UPF 75 can be changed so as to be allocated to the traffic other than the specified traffic.

The configuration for switching the offload destination is not limited to Specific Examples 1 to 3 described above. For example, the UE 50 may have two SIM cards, and may assign different SIM cards to a PDU session to the cloud and a PDU session to the edge server to switch between the PDU session to the cloud and the PDU session to the edge server. The offloading destination may be switched in this manner.

### Functions and Effects of First Embodiment

According to the first embodiment, switching of the offloading destination of the UE 50 can be controlled on the 5GC side. Accordingly, no configuration for switching the offloading destination needs to be added to the UE 50, the server on the cloud, and the edge server, which can reduce the weights of these devices. According to the first embodiment, the offloading destination of the UE 50 can be dynamically switched between the server on the cloud and the edge server.

### Other Embodiments

The above embodiment is merely illustrative, and the present disclosure may be modified as appropriate without departing from the spirit and scope of the present disclosure.

In the first embodiment, it is described that the technology for dynamically switching the offloading destination of traffic from a terminal is applied to a 5G network. However, this technology may be applied to networks other than a 5G network. For example, the technology for dynamically switching the offloading destination of traffic from a terminal as described in the first embodiment can be applied not only to different mobile communication networks such as a 4G network, a Long Term Evolution (LTE) network, and a 6G network, but also to a core network (backbone network) of a wired network, by providing devices functioning as the ECSF 1 and the NWDAF 2 inside or outside the core network. The ECSF 1 and the NWDAF 2 may run on the same information processing device.

In the first embodiment, the ECSF 1 acquires, from the NWDAF 2, information regarding the communication quality between the specified UE 50 and the edge UPF and information regarding the communication quality between the edge UPF and the specified server on the cloud, and determines to switch the offloading destination of the traffic from the UE 50 based on the communication quality between the specified UE 50 and the specified server on the cloud. However, the present disclosure is not limited to this. The ECSF 1 may acquire information regarding the communication quality between the edge UPF and the specified server on the cloud from the NWDAF 2, and may determine to switch the offloading destination of the traffic from the UE 50 connected to the edge UPF based on this information.

For example, the processes and means described in the present disclosure can be combined as desired as long as no technical contradiction occurs.

The processes described as being performed by a single device may be performed in a distributed manner by a plurality of devices. Alternatively, the processes described as being performed by different devices may be performed by a single device. In a computer system, the hardware configuration (server configuration) that implements functions can be flexibly changed.

The present disclosure can also be implemented by supplying computer programs that implement the functions described in the above embodiments to a computer and causing one or more processors of the computer to read and execute the computer programs. Such computer programs may be provided to the computer by a non-transitory computer-readable storage medium that can be connected to a system bus of the computer, or may be provided to the computer via a network. Examples of the non-transitory computer-readable storage medium include: any type of disk or disc such as magnetic disk (floppy (registered trademark) disk, hard disk drive (HDD), etc.) and optical disc (compact disc read-only memory (CD-ROM), digital versatile disc (DVD), Blu-ray disc, etc.); a read-only memory (ROM); a random access memory (RAM); an erasable programmable read-only memory (EPROM); an electrically erasable programmable read-only memory (EEPROM); a magnetic card; a flash memory; an optical card; and any type of medium suitable for storing electronic instructions.

What is claimed is:

1. An information processing method that is performed by a computer, the method comprising:
acquiring first communication quality of a path on a user plane connecting to an external network within a core network; and
when, based on the first communication quality, determination is made to switch an offloading destination of traffic from a terminal between a first server on the external network and a second server in a local network, sending to the core network a first request instructing to change steering of the traffic from the terminal.

2. The information processing method according to claim 1, further comprising:
when the first communication quality satisfies a first condition indicating that communication for the external network is stable, determining the first server on the external network to be the offloading destination, and sending to the core network the first request instructing to change a steering destination of the traffic from the terminal from the local network to the external network; and
when the first communication quality does not satisfy the first condition, determining the second server in the local network to be the offloading destination, and sending to the core network the first request instructing to change the steering destination of the traffic from the terminal from the external network to the local network.

3. The information processing method according to claim 1, further comprising:
acquiring communication quality between the terminal and the core network for each of terminals;
when second communication quality between a first terminal and the first server on the external network satisfies a second condition, determining the first server on the external network to be an offloading destination of traffic from the first terminal, and sending to the core network the first request instructing to change a steering destination of the traffic from the first terminal from the local network to the external network; and
when the second communication quality does not satisfy the second condition, determining the second server in the local network to be the offloading destination of the traffic from the first terminal, and sending to the core network the first request instructing to change the steering destination of the traffic from the first terminal from the external network to the local network.

4. The information processing method according to claim 1, wherein:
the core network is a fifth generation core network;
the method further includes
acquiring, from a Network Data Analytics Function, communication quality between a User Plane Function and the external network as the first communication quality, and
sending the first request to a Policy Control Function within the core network; and
change of the steering of the traffic from the terminal based on the first request is notified to a Session Management Function by the Policy Control Function, and is performed by the Session Management Function controlling a predetermined User Plane Function.

5. The information processing method according to claim 4, further comprising:
when the first communication quality satisfies a first condition indicating that communication for the external network is stable, determining the first server on the external network to be the offloading destination, and sending to the Policy Control Function the first request instructing to change a steering destination of the traffic from the terminal from the local network to the external network; and
when the communication quality does not satisfy the first condition, determining the second server in the local network to be the offloading destination, and sending to the Policy Control Function the first request instructing to change the steering destination of the traffic from the terminal from the external network to the local network.

6. The information processing method according to claim 4, further comprising:
acquiring, from the Network Data Analytics Function, communication quality between the terminal and a first User Plane Function and communication quality between the first User Plane Function and the first server on the external network for each of terminals;
when second communication quality between a first terminal and the first server on the external network satisfies a second condition, determining the first server to be an offloading destination of traffic from the first terminal, and sending to the Policy Control Function the first request instructing to change a steering destination of the traffic from the first terminal from the local network to the external network; and
when the second communication quality does not satisfy the second condition, determining the second server in the local network to be the offloading destination of the traffic from the first terminal, and sending to the Policy Control Function the first request instructing to change the steering destination of the traffic from the first terminal from the external network to the local network.

7. The information processing method according to claim 4, wherein:
the predetermined User Plane Function is located between a first terminal and the external network and acting as an Uplink Classifier; and
the method further includes, by changing steering of traffic from the first terminal by the Uplink Classifier based on the first request, forwarding the traffic from the first terminal to either the external network or the local network where a server that is a new offloading destination indicated by a result of the determination to switch the offloading destination is present.

8. The information processing method according to claim 4, wherein:
the predetermined User Plane Function is a Branching Point located between a first terminal and a first Protocol Data Unit Session Anchor-User Plane Function connected to the external network and located between the first terminal and a second Protocol Data Unit Session Anchor-User Plane Function connected to the local network; and
the method further includes, by changing steering of traffic from the first terminal by the User Plane Function based on the first request, forwarding, based on an IPV6 prefix, the traffic from the first terminal to either the first Protocol Data Unit Session Anchor-User Plane Function or the second Protocol Data Unit Session Anchor-User Plane Function that is a Protocol Data Unit Session Anchor-User Plane Function connected to a network where a server that is a new offloading destination indicated by a result of the determination to switch the offloading destination is present.

9. The information processing method according to claim 4, wherein:
the predetermined User Plane Function is a first Protocol Data Unit Session Anchor-User Plane Function connected to the external network and a second Protocol Data Unit Session Anchor-User Plane Function connected to the local network; and
the method further includes, when changing steering of traffic from a first terminal based on the first request, establishing by the Session Management Function a new Protocol Data Unit session between the first terminal and one of the first Protocol Data Unit Session Anchor-User Plane Function and the second Protocol Data Unit Session Anchor-User Plane Function that is connected to a network where a server that is a new offloading destination indicated by a result of the determination to switch the offloading destination is present, and releasing an exiting session between the first terminal and another of the first Protocol Data Unit Session Anchor-User Plane Function and the second Protocol Data Unit Session Anchor-User Plane Function to steer the traffic from the first terminal to either the first Protocol Data Unit Session Anchor-User Plane Function or the second Protocol Data Unit Session Anchor-User Plane Function that is connected to the network where the server that is the new offloading destination indicated by the result of the determination to switch the offloading destination is present.

10. The information processing method according to claim 4, further comprising:
sending the first request to a Network Exposure Function; and
notifying the Policy Control Function of the first request by the Network Exposure Function.

11. The information processing method according to claim 3, further comprising determining to switch an offloading destination of traffic of a first application out of the traffic from the first terminal.

12. The information processing method according to claim 11, wherein the first application is an application whose response latency is required to be smaller than a predetermined value and whose processing occurs continuously.

13. An information processing device comprising a processor configured to
acquire first communication quality of a path on a user plane connecting to an external network within a core network, and
when, based on the first communication quality, determination is made to switch an offloading destination of traffic from a terminal between a first server on the external network and a second server in a local network, send to the core network a first request instructing to change steering of the traffic from the terminal.

14. The information processing device according to claim 13, wherein the processor is configured to
acquire communication quality between the terminal and the core network for each of terminals,
when second communication quality between a first terminal and the first server on the external network satisfies a second condition, determine the first server on the external network to be an offloading destination of traffic from the first terminal, and send to the core network the first request instructing to change a steering destination of the traffic from the first terminal from the local network to the external network, and
when the second communication quality does not satisfy the second condition, determine the second server in the local network to be the offloading destination of the traffic from the first terminal, and send to the core network the first request instructing to change the steering destination of the traffic from the first terminal from the external network to the local network.

15. The information processing device according to claim 13, wherein:
the core network is a fifth generation core network;
the processor is configured to
acquire, from a Network Data Analytics Function, communication quality between a User Plane Function and the external network as the first communication quality, and
send the first request to a Policy Control Function within the core network; and
change of the steering of the traffic from the terminal based on the first request is notified to a Session Management Function by the Policy Control Function, and is performed by the Session Management Function controlling a predetermined User Plane Function.

16. The information processing device according to claim 15, wherein the processor is configured to
acquire, from the Network Data Analytics Function, communication quality between the terminal and a first User Plane Function and communication quality between the first User Plane Function and the first server on the external network for each of terminals,
when second communication quality between a first terminal and the first server on the external network satisfies a second condition, determine the first server to be an offloading destination of traffic from the first terminal, and send to the Policy Control Function the first request instructing to change a steering destination of the traffic from the first terminal from the local network to the external network, and
when the second communication quality does not satisfy the second condition, determine the second server in the local network to be the offloading destination of the traffic from the first terminal, and send to the Policy Control Function the first request instructing to change the steering destination of the traffic from the first terminal from the external network to the local network.

17. The information processing device according to claim 15, wherein
the processor is configured to send the first request to a Network Exposure Function, and
the Network Exposure Function is configured to notify the Policy Control Function of the first request.

18. A non-transitory storage medium storing instructions that are executable by one or more processors and that cause the one or more processors to perform functions comprising:
Acquiring first communication quality of a path on a user plane connecting to an external network within a core network; and
when, based on the first communication quality, determination is made to switch an offloading destination of traffic from a terminal between a first server on the external network and a second server in a local network, sending to the core network a first request instructing to change steering of the traffic from the terminal.

19. The non-transitory storage medium according to claim 18, wherein:
the core network is a fifth generation core network;
the functions further include
acquiring, from a Network Data Analytics Function, communication quality between a User Plane Function and the external network as the communication quality of the path on the user plane connecting to the external network within the core network, and
sending the first request to a Policy Control Function within the core network; and
change of the steering of the traffic from the terminal based on the first request is notified from the Policy Control Function to a Session Management Function, and is performed by the Session Management Function controlling a predetermined User Plane Function.

20. The non-transitory storage medium according to claim 19, wherein the functions further include
acquiring, from the Network Data Analytics Function, communication quality between the terminal and a first User Plane Function and communication quality between the first User Plane Function and the first server on the external network for each of terminals,
when second communication quality between a first terminal and the first server on the external network satisfies a second condition, determining the first server to be an offloading destination of traffic from the first terminal, and sending to the Policy Control Function the first request instructing to change a steering destination of the traffic from the first terminal from the local network to the external network, and
when the second communication quality does not satisfy the second condition, determining the second server in the local network to be the offloading destination of the traffic from the first terminal, and sending to the Policy Control Function the first request instructing to change the steering destination of the traffic from the first terminal from the external network to the local network.
